(19) United States
(12) Patent Application Publication
(10) Pub. No.: US 2024/0183745 A1
(43) Pub. Date: Jun. 6, 2024

(54) TESTING DEVICE

(71) Applicant: STMicroelectronics (Crolles 2) SAS, Crolles (FR)

(72) Inventors: Stephanie AUDRAN, Le Touvet (FR); Elodie SUNGAUER, St Vincent de Mercuze (FR); Simon GUILLAUMET, Grenoble (FR)

(73) Assignee: STMicroelectronics (Crolles 2) SAS, Crolles (FR)

(21) Appl. No.: 18/523,756

(22) Filed: Nov. 29, 2023

(30) Foreign Application Priority Data
Dec. 6, 2022 (FR) 2212858

(51) Int. Cl. G01M 11/02

(52) U.S. Cl. CPC G01M 11/0207

(57) ABSTRACT

A device for testing an optical device, comprising a first structure comprising a substrate made of a first material and at least two first pillars of cylindrical shape made of a second material crossing the substrate, the second material having an optical index different from the optical index of the first material.

### CROSS-REFERENCE TO RELATED APPLICATION

This application claims the priority benefit of French patent application number FR2212858, filed on Dec. 6, 2022 entitled “Dispositif de test”, which is hereby incorporated by reference to the maximum extent allowable by law.

### BACKGROUND

### Technical Field

The present disclosure generally concerns optical systems and devices, and more particularly the manufacturing of optical systems and devices. The present disclosure more particularly relates to a testing and metrology device used during the manufacturing of optical systems and devices, and more particularly during the manufacturing of optical systems and devices comprising optical meta-structures.

### Description of the Related Art

Optical systems and devices, such as lenses, filters, beam shapers, mirrors, diffusers, etc., are currently used nowadays and are more and more used in optoelectronic devices and the imaging industry. There are commonly optical systems and devices embedded in popular electronics such as smartphones. Some optical objects include metastructures and silicon(Si)-based materials that are embedded in transparent materials.

The optical systems can be made with different technology such as molding, stamping, and nanoimprint lithography. However, there are drawbacks of using known metrology techniques and tools, such as Transmission Electron Microscopy (TEM), Scatterometry.

In standard complementary metal-oxide semiconductor (CMOS) technology, the patterning development, using for example lithography and etching, is focused on one or two specific critical dimension (CD) structures, which are mandatory to have in target. The patterning development is done using one or a single metrology structure called “mesdim” that is generally representative of the most critical patterning to transfer or include that contains the one single critical dimension.

In metasurface-based optical technology, the patterning development must guarantee that all the metasurface critical dimensions are in target in order to ensure the right optical performance of the optical component. Metasurface products can be made of a continuity of 100-200 dots of different diameters.

A recognized problem is the standard use of or reliance on one single critical dimension mesdim, which is inefficient to develop the patterning of the metasurface. In particular, it cannot be guaranteed that the full range of critical dimensions present in the product will be in specification. Using mesdim with one single pattern does not enable tracking the potential etch density effect on the critical dimension.

Conversely, if different regular critical dimension mesdims are used, then catching the potential etch density effect on the critical dimension is not guaranteed since the critical dimension measurement directly in the product is very difficult due to the random spatial repartition of the dots. For example, potential placement error of critical dimension scanning electron microscope (CD-SEM) could lead to bad correlation between critical dimension measured versus targeted critical dimension. Thus, there is a need to carry out complementary metrology directly in the product.

### BRIEF SUMMARY

The present disclosure is directed to developing a metasurface by photolithography. Some embodiments of the present disclosure are directed to solutions of metasurface embedded metrology structures.

One embodiment takes into account the etch density effect on critical dimension and guarantees the full range of critical dimension present in the product is in the specification.

Another embodiment includes mesdim or mesdims with the same dimensions or variable critical dimension mesdim rather than the standard single critical dimension mesdims. Mesdim that contains variable critical dimensions, structures, or combination thereof, are representative of the variety and range of critical dimension present in the product. In one embodiment, the mesdim includes at least the minimum dimension, the maximum dimension, the median dimension, and as well as additional dimensions between those dimensions. The spatial repartition of these structures or dots can be of different ways, such as regular, organized, random, or other suitable arrangement.

There exists a need for higher performance and more reliable methods of manufacturing of optical systems and devices.

There exists a need for more reliable devices for testing optical systems and devices, and their manufacturing methods.

An embodiment overcomes all or part of the disadvantages of known devices for testing optical systems and devices.

An embodiment provides a device for testing an optical device, comprising a first structure comprising a substrate made of a first material and at least two first pillars of cylindrical shape made of a second material crossing or traversing said substrate.

According to an embodiment, said at least two first pillars have cross-sections of different diameters.

According to an embodiment, said at least two first pillars have cross-sections with diameters in the range from 50 nm to 4 μm.

According to an embodiment, said at least two first pillars have cross-sections of different shapes.

According to an embodiment, said at least two first pillars have a cross-section having a shape from the group comprising: a disk, an oval, an ellipse, a polygon, a hexagon, a rectangle, a diamond, and a square.

According to an embodiment, the first material is different from the second material.

According to an embodiment, the first material is selected from the group comprising: quartz, a compound comprising quartz, silicon, a compound comprising silicon, silicon oxide, silicon nitride, a compound of silicon and carbon, metal oxides of silicon, glass, a compound comprising glass, a compound of aluminum, such as a compound of aluminum and arsenic, and a compound of gallium, such as a compound of gallium and arsenic.

According to an embodiment, the second material is selected from the group comprising: quartz, a compound comprising quartz, silicon, a compound comprising silicon, silicon oxide, silicon nitride, a compound of silicon and carbon, metal oxides of silicon, glass, a compound comprising glass, a compound of aluminum, such as a compound of aluminum and arsenic, and a compound of gallium, such as a compound of gallium and arsenic.

According to an embodiment, said first structure is an optical meta-structure.

Another embodiment provides an optical system comprising said testing device and an optical device.

According to an embodiment, said optical device comprises a second structure comprising a substrate made of the first material and at least two second pillars made of the second material crossing or traversing said substrate.

According to an embodiment, said at least two first pillars have a diameter between a minimum diameter of said at least two second pillars and a maximum diameter of said at least two second pillars.

According to an embodiment, one of said at least two first pillars has a diameter equal to the average diameter of said at least two second pillars.

According to an embodiment, said at least two first pillars have a cross-section of the same shape as the cross-section of said at least two second pillars.

According to an embodiment, said testing device is positioned at the level of a cutting line or kerf of said optical device.

According to an embodiment, said testing device is positioned outside of a cutting line of said optical device.

Another embodiment provides a method of manufacturing said testing device using manufacturing techniques of the field of microelectronics.

An embodiment includes putting in the frame a dedicated mesdim containing a range of polygon shapes of different critical dimensions representative of what meets specification requirements and could be found in the product. This mesdim could be place in the frame or in the periphery of the product. The polygon shape can be dot, ellipses, rectangle, or other suitable shapes. The range of polygon includes critical dimensions including and between the minimum, maximum, median critical dimensions of the product. The desired critical dimension mesdim and shape is chosen in order to guaranty that if the critical dimensions are in specs in the mesdim, then the continuity of critical dimensions available will be in specification in the final product. The spatial repartition or spacing of the polygon of the different critical dimension can be of different ways. In some embodiments, the polygon are spaced apart in a regular, consistent, or even arrangement from each other. In another embodiment, the polygon are spaced apart from each other at random with various distances between each other. These methods incorporate and consider the etch density effect that could occur in the product.

### BRIEF DESCRIPTION OF THE SEVERAL VIEWS OF THE DRAWINGS

The foregoing features and advantages, as well as others, will be described in detail in the rest of the disclosure of specific embodiments given by way of illustration and not limitation with reference to the accompanying drawings, in which:

FIG. 1 shows a top view of an example of embodiment of an optical meta-structure;

FIG. 2 shows a cross-section view of an example of embodiment of an optical meta-structure;

FIG. 3 shows a top view of examples of embodiment of pillars of an optical meta-structure;

FIG. 4 very schematically shows in the form of blocks a top view of a step of a method of manufacturing the optical devices;

FIGS. 5A and 5B are two views very schematically showing in the form of blocks two embodiments of a device for testing an optical device; and

FIG. 6 very schematically shows in the form of blocks an embodiment of an optical system comprising the embodiment of FIG. 5.

### DETAILED DESCRIPTION

Like features have been designated by like references in the various figures. In particular, the structural and/or functional features that are common among the various embodiments may have the same references and may dispose identical structural, dimensional and material properties.

For the sake of clarity, only the steps and elements that are useful for an understanding of the embodiments described herein have been illustrated and described in detail. In particular, all the optical devices that can be formed with a meta-structure are not detailed.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, when reference is made to absolute positional qualifiers, such as the terms “front”, “back”, “top”, “bottom”, “left”, “right”, etc., or to relative positional qualifiers, such as the terms “above”, “below”, “upper”, “lower”, etc., or to qualifiers of orientation, such as “horizontal”, “vertical”, etc., reference is made, unless specified otherwise, to the orientation of the figures.

Unless specified otherwise, the expressions “around”, “approximately”, “substantially” and “in the order of” signify within 10%, and preferably within 5%.

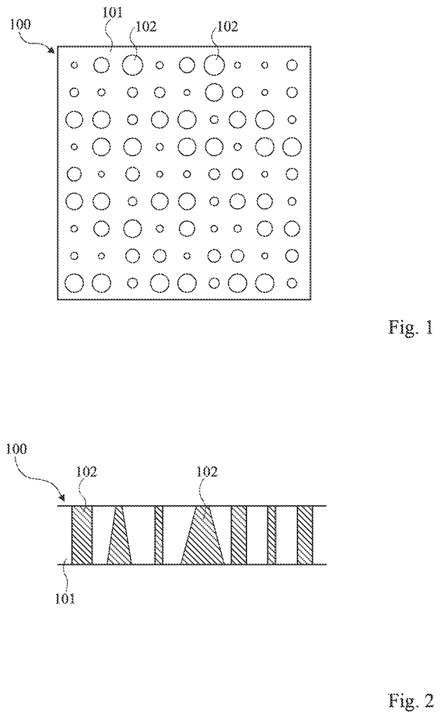

FIGS. 1 and 2 are simplified top and cross-section views of an example of embodiment of an optical meta-structure 100. More particularly, FIG. 1 illustrates a portion of meta-structure 100, and FIG. 2 illustrates a portion of a row or of a column of pillars of meta-structure 100.

Optical meta-structure 100 is a structure formed of a substrate wafer 101, or substrate, through formed pillars 102, or cylinders 102, or cones 102. Pillars 102 cross the substrate wafer and are generally made of a material different from the material of the substrate wafer. According to an embodiment, the material of pillars 102 has a different optical index than the material of the substrate wafer. According to an example, pillars 102 thoroughly cross the substrate wafer. According to another example, pillars 102 cross a portion of the substrate wafer and their ends are covered with a portion of the substrate wafer or by different layers of materials, such as, for example, etch stop layers and/or optical anti-reflection layers. Substrate wafer 101 may for example have a thickness in the range from 10 nm to 10 μm.

According to an example, the material of substrate wafer 101 is selected from the non-exhaustive group comprising: quartz, a compound comprising quartz, silicon, a compound comprising silicon, silicon oxide, silicon nitride, a compound of silicon and carbon, metal oxides of silicon, glass, a compound comprising glass, a compound of aluminum, such as a compound of aluminum and arsenic, and a compound of gallium, such as a compound of gallium and arsenic.

According to an example, the material of pillars 102 is selected from the non-exhaustive group comprising: quartz, a compound comprising quartz, silicon, a compound comprising silicon, silicon oxide, silicon nitride, a compound of silicon and carbon, metal oxides of silicon, glass, a compound comprising glass, a compound of aluminum, such as a compound of aluminum and arsenic, and a compound of gallium, such as a compound of gallium and arsenic.

Pillars 102 are generally arranged in the form of an array, that is, in rows and in columns with a regular interval. According to another embodiment, pillars 102 are arranged with a spatial arrangement where they are spaced apart with an irregular interval.

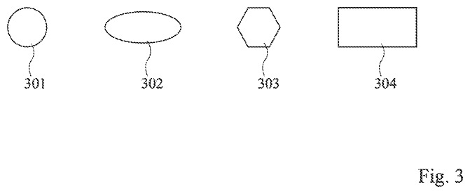

Pillars 102 are generally of cylindrical or conical shape with main axes all parallel to one another and having a cross-section that may have different diameters and different shapes. More particularly, there is here called a diameter of a pillar 102 is the diameter of a fictive circle having the shape of the cross-section of pillar 102, that is, the greatest width of the shape of the cross-section of pillar 102, inscribed therein. According to an example, the diameter of a pillar 102 may be in the range from 50 nm to 4 μm. The cross-section of pillars 102 may have different shapes, which is described in further details in relation with FIG. 3. Further, there is called, in the following description, a shape of a pillar 102 the shape of the cross-section of a pillar 102.

An optical meta-structure may be used to form any types of optical devices, such as converging lenses, diverging lenses, optical filters, diffusers, etc. To obtain these different optical properties, it is necessary to use pillars having different diameters and/or shapes in the same structure, and to use an appropriate distribution of these different pillars. According to an example, a random distribution of pillars of different diameters may enable to create a meta-structure with a diffuser function, while a non-random distribution, for example, with a diameter of pillars 102 decreasing or increasing towards a central point of the structure, may enable to form a converging or diverging lens function.

An example of a method of manufacturing meta-structure 100 uses techniques used in the field of electronics and of microelectronics, that is, the use of the method of etching, deposition, masking and/or lithography used for the manufacturing of electronic and micro-electronic components.

FIG. 3 shows different shapes that may be taken of a pillar of a meta-structure of the type of the meta-structure 100 described in relation with FIGS. 1 and 2.

FIG. 3 more particularly shows four shapes 301, 302, 303, and 304 that the cross-section of a pillar may have. FIG. 3 does not show all the shapes that a pillar can take, other shapes are within the abilities of those skilled in the art.

According to a first example, the pillars may have the shape 301 of a disk, or substantially equal to a disk.

According to a second example, the pillar may have the shape 302 of an oval, or substantially equal to an oval, or the shape of an ellipse, or substantially equal to an ellipse.

According to a third example, the pillar may have the shape 303 of a regular polygon, or substantially a regular polygon shape, such as a hexagon shape shown in FIG. 3, or any other regular polygon shape, such as a diamond, a square, a pentagon, a hexagon, etc. The pillar may have the shape of a regular polygon with rounded apexes.

According to a fourth example, the pillar may have the shape 304 of a non-regular polygon, or substantially equal to a non-regular polygon, such as a rectangle. The pillar may have the shape of a non-regular polygon with rounded apexes.

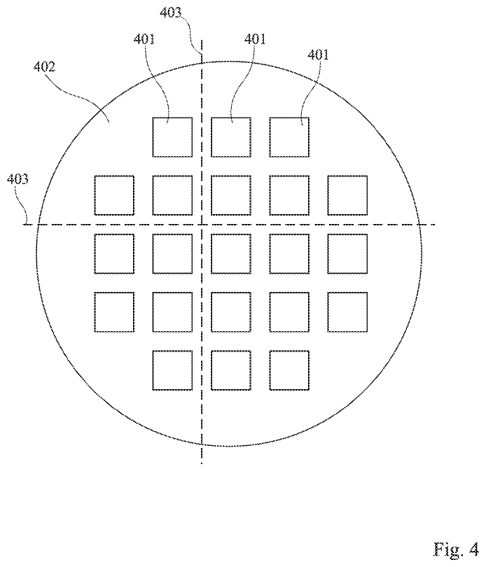

FIG. 4 is a top view of an embodiment of a step of a method of manufacturing a plurality of optical devices 401 using a meta-structure of the type of the meta-structure 100 described in relation with FIGS. 1 and 2.

As previously mentioned, a meta-structure of the type of meta-structure 100 may be manufactured by using manufacturing techniques of the field of electronics and of microelectronics. Thus, it is possible to manufacture, in parallel, a plurality of optical devices 401 comprising a meta-structure on a same substrate wafer 402. The step illustrated in FIG. 4 shows substrate wafer 402 after the manufacturing of the meta-structures used to form optical devices 401, and before the singulation of optical devices 401.

At the step of FIG. 4, optical devices 401 are arranged in rows and in columns on substrate wafer 402, and are regularly or substantially regularly spaced apart. After this step, optical devices 401 are singulated by cutting. According to an example, optical devices 401 are singulated by following cutting lines 403 arranged between the rows and columns of devices 403. Different cutting methods of the field of electronics and of microelectronics may be used herein, and are within the abilities of those skilled in the art.

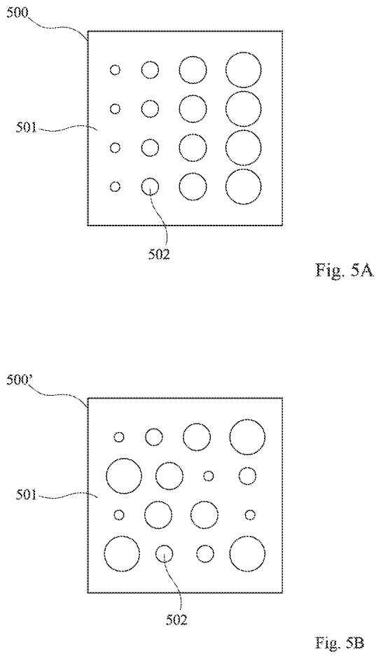

FIGS. 5A and 5B are two views showing two embodiments of devices 500 and 500′ for testing an optical device of the type of the optical devices 401 described in relation with FIG. 4.

Testing device 500 is formed of a meta-structure, of the type of the meta-structure 100 described in relation with FIG. 1, comprising a substrate wafer 501, or substrate 501, and pillars 502. Testing device 500 preferably has dimensions, that is, a length and a width, smaller than or equal to those of the optical device with which it is associated. Besides, testing device 500 may further be associated with a plurality of identical or similar optical devices.

Further, testing device 500 comprises pillars 502 having a diameter and a shape representative of the diameters and of the shapes of the pillars of the optical device with which it is associated. Testing device 500 may for example comprise at least one item of each type of pillars used in the optical device with which it is associated, that is, all the diameter and shape combinations, or only comprise certain types of pillars. According to an example, if the pillars of the optical device vary between a minimum diameter Dmin and a maximum diameter Dmax, the testing device may comprise pillars having their diameter varying between diameters Dmin and Dmax with a defined pitch p. According to a practical example, if the optical device comprises disk-shaped pillars having their diameter varying between 100 and 500 nm, testing device 500 may also comprise disk-shaped pillars 502 having their diameter varying between 100 and 500 nm with a pitch in the range from 5 to 100 nm.

Further, testing device 500 may exhibit a distribution of pillars 502 similar to the distribution of the pillars of the optical device with which it is associated. According to an example, if the optical device comprises a random distribution of pillars of different diameters and/or of different shapes, the testing device may also comprise a random distribution of pillars 502 of different diameters and/or of different shapes. An example of linear distribution by increasing diameter is illustrated in FIG. 5A.

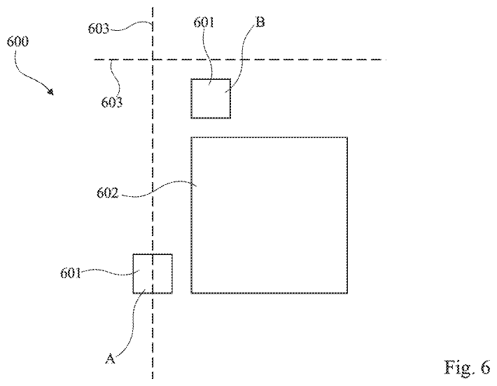

Testing device 500 may be manufactured by using the same manufacturing techniques as those used for the manufacturing of the optical device with which it is associated. Thus, testing device 500 may be manufactured by using techniques of the field of electronics and of microelectronics, which are within the abilities of those skilled in the art. Testing device 500 may be manufactured at the same time as the optical device with which it is associated, and it may be manufactured on the same substrate wafer as the optical device. Different types of positioning of testing device 500 are described in further detail in relation with FIG. 6.

Testing device 500 may have a multitude of uses.

According to a first example, testing device 500 may be used to test the equipment implemented for the manufacturing of the optical device. More particularly, testing device 500 may enable to verify whether the dimensions of the pillars and/or their spacing may be achieved by using the methods and equipment envisaged for the manufacturing of the optical device. In this case, testing device 500 is manufactured before the manufacturing of the optical device.

According to a second example, testing device 500 may be used as a test of the quality of the manufacturing method. By manufacturing testing device 500 at the same time and on the same substrate wafer as the optical device with which it is associated, it is possible to verify whether the optical device manufacturing method has been correctly implemented and, possibly, to verify whether the manufacturing method has been implemented with the desired accuracy.

According to a third example, testing device 500 may be used as a test during the elaboration or the optimization of the method of manufacturing the optical device, for example to verify their operation and/or their accuracy.

According to a fourth example, testing device 500 may be used as means of identification of the optical device, indeed it is possible by varying the distribution of pillars 502 to form a pattern enabling to identify the optical device associated with the testing device.

Testing device 500′ is similar to testing device 500, but comprises a random distribution of pillars 502.

A practical example of design of a testing device of the type of testing device 500 or of the type of testing device 500′ is the following. If the testing device is associated with an optical meta-structure and comprises ten pillars, then:
a first pillar may have the minimum diameter of a pillar used in said meta-structure;
a second pillar may have the maximum diameter of a pillar used in said meta-structure;
a third pillar may have the average diameter of the pillars used in the meta-structure; and
the last seven pillars may have diameters selected at a regular interval between the minimum diameter and the maximum diameter.

Further, the distribution of the ten pillars may be similar to the distribution of the pillars used in the meta-structure.

FIG. 6 is a simplified top view of an optical device 600.

Optical system 600 comprises a testing device 601 of the type of the testing device 500 described in relation with FIG. 5 and an optical device 602, of the type of the optical device 401 described in relation with FIG. 4, associated. In the case of optical system 600, testing device 601 and optical device 602 have been manufactured in parallel and on a same substrate wafer.

Testing device 601 may be positioned in a plurality of ways with respect to optical device 602.

According to a first example, testing device 601 may only be intended to perform tests during the manufacturing of optical device 601 and to be useful to the manufacturer of optical device 601. Testing device 601 may in this case be intended to be destroyed at the end of the manufacturing. Thus, an option is to place testing device 601 at the level of a cutting line 603 of optical device 602. Cutting line 403 is of the same type as the cutting lines described in relation with FIG. 4. This position is designated with reference A in FIG. 6.

According to a second example, testing device 601 may be used by the user of optical device 602, for example to verify the accuracy of the optical device for identification purposes as previously explained. In this case, testing device 601 must not be destroyed and can then be arranged between device 602 and a cutting line 603. This position is designated with reference B in FIG. 6.

According to a third example not illustrated in FIG. 6, testing device 601 may be common to a plurality of identical or similar optical devices 602. In this case, the position of testing device 601 on a substrate wafer matters little, and it may be positioned on a cutting line of the substrate wafer, or on a portion of the substrate wafer which is not used afterwards.

Various embodiments and variants have been described. Those skilled in the art will understand that certain features of these various embodiments and variants may be combined, and other variants will occur to those skilled in the art.

Finally, the practical implementation of the described embodiments and variations is within the abilities of those skilled in the art based on the functional indications given hereabove.

Device (500; 601) for testing an optical device (401; 602) may be summarized as including a first structure (100) comprising a substrate (101; 501) made of a first material and at least two first pillars (102; 502) of cylindrical shape made of a second material crossing said substrate (101; 501), the second material having an optical index different from the optical index of the first material.

Device wherein said at least two first pillars (102; 502) may have cross-sections of different diameters.

Device wherein said at least two first pillars (102; 502) may have cross-sections with a diameter in the range from 50 nm to 4 μm.

Device wherein said at least two first pillars (102; 502) may have cross-sections of different shapes.

Device wherein said at least two first pillars (102; 502) may have a cross-section having a shape from the group comprising: a disk, an oval, an ellipse, a polygon, a hexagon, a rectangle, a diamond, and a square.

Device wherein the first material may be different from the second material.

Device wherein the first material may be selected from the group comprising: quartz, a compound comprising quartz, silicon, a compound comprising silicon, silicon oxide, silicon nitride, a compound of silicon and carbon, metal oxides of silicon, glass, a compound comprising glass, a compound of aluminum, such as a compound of aluminum and arsenic, and a compound of gallium, such as a compound of gallium and arsenic.

Device wherein the second material may be selected from the group comprising: quartz, a compound comprising quartz, silicon, a compound comprising silicon, silicon oxide, silicon nitride, a compound of silicon and carbon, metal oxides of silicon, glass, a compound comprising glass, a compound of aluminum, such as a compound of aluminum and arsenic, and a compound of gallium, such as a compound of gallium and arsenic.

Device wherein the first structure may be an optical meta-structure.

Optical system may be summarized as including a testing device (500; 601) and an optical device (401; 602).

Optical system wherein said optical device (401; 602) may include a second structure (100) comprising a substrate (101) made of the first material and at least two second pillars (102) made of the second material crossing said substrate (101).

Optical system wherein said at least two first pillars (102; 502) may have a diameter between a minimum diameter of said at least two second pillars (102) and a maximum diameter of said at least two second pillars (102).

Optical system wherein one of said at least two first pillars (102; 502) may have a diameter equal to the average diameter of said at least two second pillars (102).

Optical system wherein said at least two first pillars (102; 502) may have a cross-section of same shape as the cross-section of said at least two second pillars (102).

Optical system wherein said testing device (500; 601) may be positioned at the level of a cutting line (403; 603) of said optical device (401; 602).

Optical system according to claim 10, wherein said testing device (500; 601) may be positioned outside of a cutting line (403; 603) of said optical device (401; 602).

Method of manufacturing a testing device (401; 602) may use manufacturing techniques of the field of microelectronics.

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A device comprising:
a testing device, including:
a first structure including:
a substrate made of a first material; and
at least two first pillars of cylindrical shape made of a second material crossing the substrate, the first material having a first optical index, and the second material having a second optical index different from the first optical index.

2. The device according to claim 1, wherein the at least two first pillars have cross-sections of different diameters from each other.

3. The device according to claim 2, wherein the at least two first pillars have cross-sections with diameters in the range from 50 nm to 4 μm.

4. The device according to claim 1, wherein the at least two first pillars have cross-sections of different shapes from each other.

5. The device according to claim 1, wherein the at least two first pillars have a cross-section having a shape of one of the following: a disk, an oval, an ellipse, a polygon, a hexagon, a rectangle, a diamond, and a square.

6. The device according to claim 1, wherein the first material is different from the second material.

7. The device according to claim 1, wherein the first material is selected from one of the following: quartz, a compound comprising quartz, silicon, a compound comprising silicon, silicon oxide, silicon nitride, a compound of silicon and carbon, metal oxides of silicon, glass, a compound comprising glass, a compound of aluminum, such as a compound of aluminum and arsenic, and a compound of gallium, such as a compound of gallium and arsenic.

8. The device according to claim 1, wherein the second material is selected from one of the following: quartz, a compound comprising quartz, silicon, a compound comprising silicon, silicon oxide, silicon nitride, a compound of silicon and carbon, metal oxides of silicon, glass, a compound comprising glass, a compound of aluminum, such as a compound of aluminum and arsenic, and a compound of gallium, such as a compound of gallium and arsenic.

9. The device according to claim 1, wherein the first structure is an optical meta-structure.

10. An optical system comprising:
a substrate of a first material having a first optical index;
a testing device on the substrate, the testing device including a first optical meta-structure having at least two first pillars crossing the substrate, the at least two first pillars being of a second material having a second optical index different from the first optical index; and
an optical device on the substrate.

11. The optical system according to claim 10, wherein the optical device includes a second optical meta-structure made of the first material and at least two second pillars made of the second material crossing the substrate.

12. The optical system according to claim 11, wherein the at least two first pillars have a diameter between a minimum diameter of the at least two second pillars and a maximum diameter of the at least two second pillars.

13. The optical system according to claim 11, wherein one of the at least two first pillars has a diameter equal to the average diameter of the at least two second pillars.

14. The optical system according to claim 11, wherein the at least two first pillars have a cross-section of same shape as the cross-section of the at least two second pillars.

15. The optical system according to claim 10, wherein the testing device is positioned at a level of a cutting line of the optical device.

16. The optical system according to claim 10, wherein the testing device is positioned outside of a cutting line of the optical device.

17. A method, comprising:
manufacturing a testing device having first dimensions; and
manufacturing a plurality of optical devices having second dimensions and a plurality of meta-structures or pillars, the first dimensions being less than or substantially equal to the second dimensions, each optical device of the plurality of optical devices having a meta-structure, the testing device having at least one meta-structure or pillar of the optical device.

18. The method of claim 17, comprising singulating the plurality of optical devices via cutting on a cutting line, the cutting line arranged between rows and columns of the plurality of optical devices.

19. The method of claim 18, wherein singulating the plurality of optical devices includes positioning the testing device on the cutting line.

20. The method of claim 17, wherein the manufacturing the testing device occurs before the manufacturing the plurality of optical devices, or the manufacturing the testing device and the manufacturing the plurality of optical devices occurs simultaneously.
